(19) United States
(12) Patent Application Publication
(10) Pub. No.: US 2008/0067990 A1
(43) Pub. Date: Mar. 20, 2008

(54) Coupled-inductor assembly with partial winding

(75) Inventor: Jia Wei, Cary, NC (US)

Correspondence Address: GRAYBEAL, JACKSON, HALEY LLP, 155 - 108TH AVENUE NE, SUITE 350, BELLEVUE, WA, 98004-5973, US

(73) Assignee: Intersil Americas Inc., Milpitas, CA (US)

(21) Appl. No.: 11/903,185

(22) Filed: Sep. 19, 2007

Related U.S. Application Data
(60) Provisional application No. 60/845,941, filed on Sep. 19, 2006.

(51) Int. Cl. G05F 1/44; H01F 27/24

(52) U.S. Cl. 323/271; 336/212

(57) ABSTRACT

An embodiment of a coupled-inductor structure includes a core and a conductor. The core includes first and second members, and spaced-apart forms extending between the members, and the conductor is partially wound about one of the forms. Because the conductor is only partially wound about a form of the core, the conductor may be shorter, wider, or both shorter and wider, and thus may have a smaller resistance, than a conductor that forms a winding of a conventional coupled-inductor structure. Consequently, a coupled-inductor structure incorporating one or more of such partially wound conductors may consume less power and generate less heat than a conventional coupled-inductor structure for given winding currents and voltages.

### CLAIM OF PRIORITY

This application claims priority to U.S. Provisional Application Ser. No. 60/845,941, filed on Sep. 19, 2006, which is incorporated by reference.

### BACKGROUND

Coupled inductors are used in circuits such as multiphase switching power supplies. For example, using coupled inductors in a multiphase buck converter may allow a designer to reduce the size (e.g., the component count and component values) of the output filter, and thus the size of the converter, for a given amplitude of the output ripple voltage.

A coupled-inductor assembly, which may be similar to a transformer, includes a magnetically permeable core and conductors wound about the core, where each wound conductor (i.e., a “winding”) forms a respective one of the coupled inductors. Because the coupled inductors are wound about a common core, magnetic flux generated by one inductor is coupled to the other inductors via the core; therefore, the inductors are magnetically coupled to one another.

Unfortunately, existing coupled-inductor assemblies may limit the power efficiency of switching power supplies and the devices that incorporate these supplies. For example, one may desire to decrease the power consumption of a laptop computer to extend battery life and to reduce the computer's CO₂ footprint. Increasing the efficiency of the computer's coupled-inductor power supply(ies) may help to decrease the computer's power consumption in a number of ways, including: 1) reducing the amount of power consumed by the power supply itself, and 2) reducing the power consumed by the computer's cooling system (e.g., a fan) by reducing the amount of heat generated by the power supply. But unfortunately, the power consumed and heat generated by existing coupled-inductor assemblies may limit the efficiency of the computer's coupled-inductor supply(ies), and thus may limit the amount by which one is able to reduce the computer's power consumption.

### SUMMARY

This Summary is provided to introduce, in a simplified form, a selection of concepts that are further described below in the Detailed Description. This Summary is not intended to identify key features or essential features of the claimed subject matter, nor is it intended to be used to limit the scope of the claimed subject matter.

An embodiment of a coupled-inductor assembly includes a core and a conductor. The core includes first and second members and spaced-apart forms extending between the members, and the conductor is partially wound about one of the forms.

Because the conductor is only partially wound about the core, the conductor may be shorter, wider, or both shorter and wider than a conductor that forms a multi-turn winding of a conventional coupled-inductor assembly; consequently, such a partial winding may have a lower resistance than a conventional multi-turn winding. This smaller resistance may allow the partial winding to consume less power and to generate less heat than a multi-turn winding for a given winding current and winding voltage. Consequently, a coupled-inductor assembly incorporating one or more such partial windings may consume less power and generate less heat than a conventional coupled-inductor assembly for given winding currents and voltages.

### BRIEF DESCRIPTION OF THE DRAWINGS

FIG. 1 is a schematic diagram of an embodiment of a multiphase buck converter that includes a coupled-inductor assembly.

FIG. 2 is a perspective view of an embodiment of a coupled-inductor assembly that may be used in the buck converter of FIG. 1.

FIG. 3 is cut-away side view of the coupled-inductor assembly of FIG. 2 and shows current flowing through one of the windings and the magnetic flux generated by the current.

FIG. 4 is a perspective view of another embodiment of a coupled-inductor assembly that may be used in the buck converter of FIG. 1.

FIG. 5 is a perspective view of another embodiment of a coupled-inductor assembly that may be used in the buck converter of FIG. 1.

FIG. 6 is a perspective view of another embodiment of a coupled-inductor assembly that may be used in the buck converter of FIG. 1.

FIG. 7 is a rear perspective view of a portion of the coupled-inductor assembly of FIG. 6.

FIG. 8 is a block diagram of an embodiment of a computer system having a multiphase power supply that includes one or more of the coupled-inductor structures of FIGS. 2 and 4-6.

### DETAILED DESCRIPTION

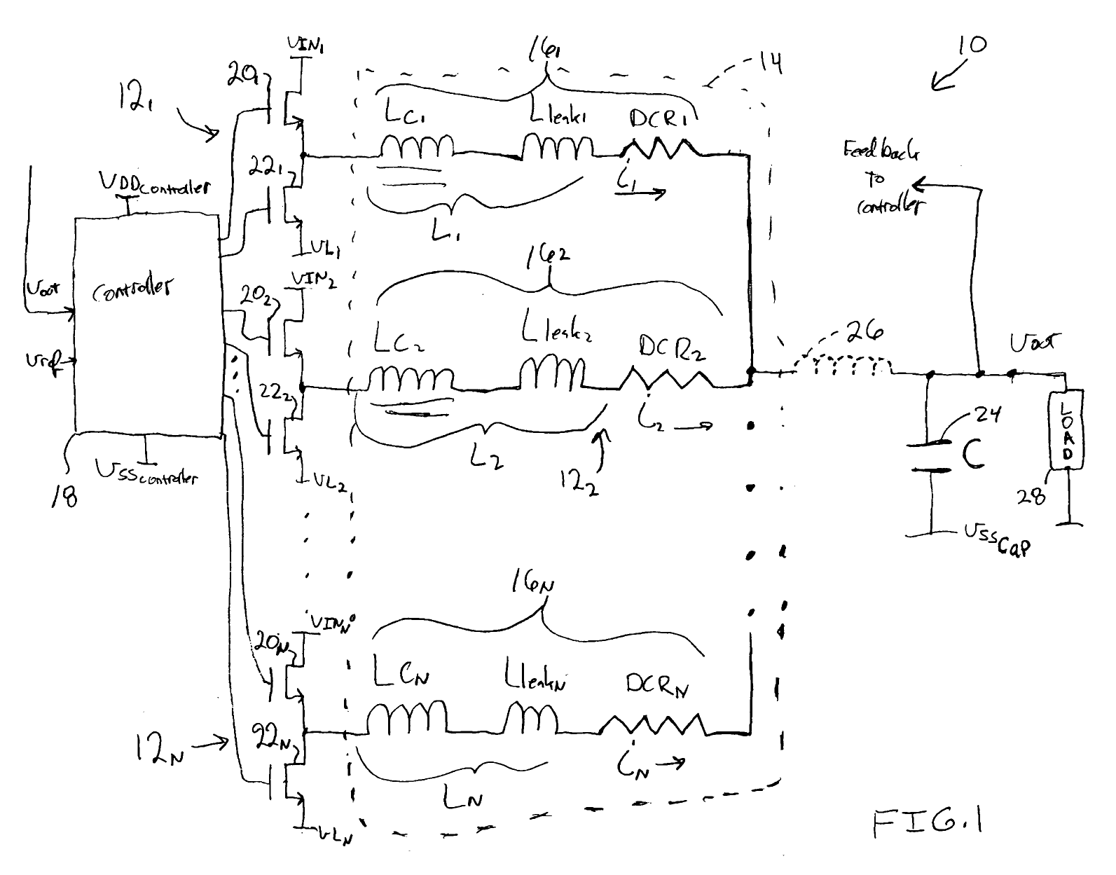

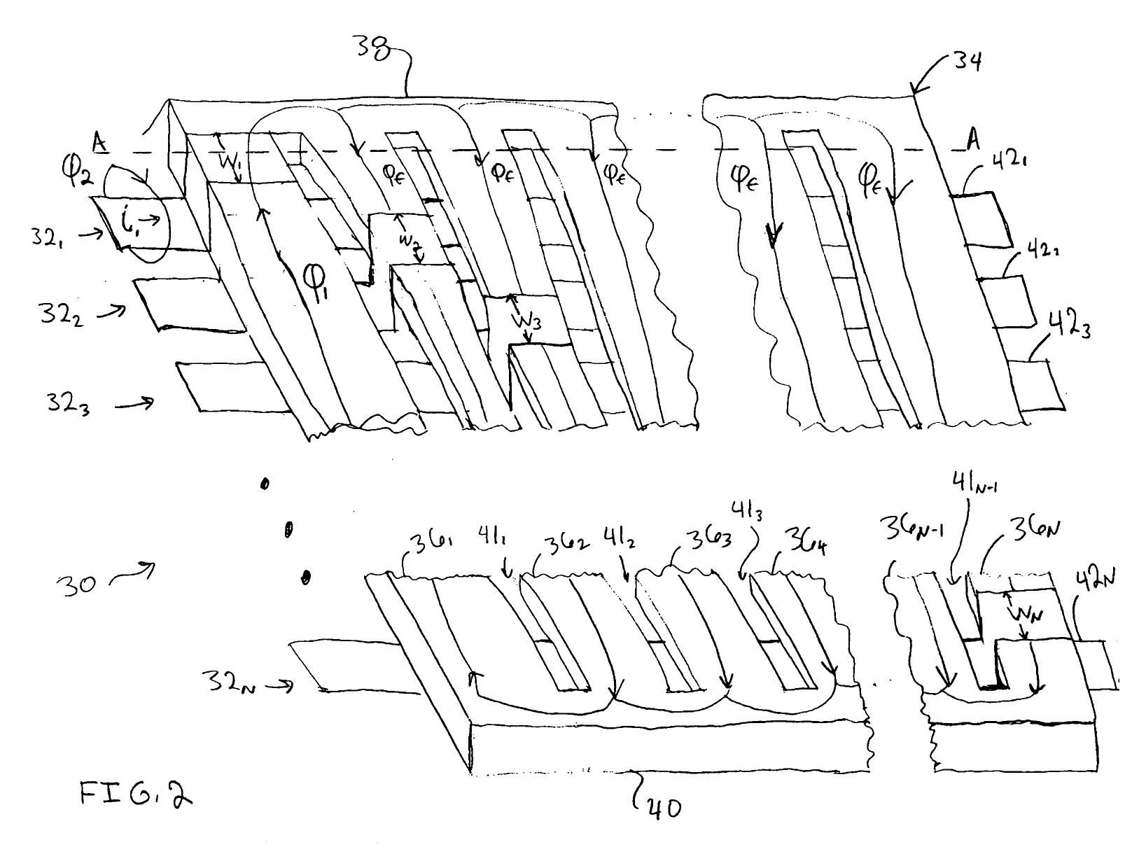

FIG. 1 is a schematic diagram of an embodiment of a multiphase buck converter 10, which includes phases 12₁-12_{N} and a coupled-inductor assembly 14 having magnetically coupled windings 16₁-16_{N}, one winding per phase. As discussed below in conjunction with FIGS. 2-7, the windings 16₁-16_{N} may each have a resistance that is less than a resistance of a conventional coupled-inductor winding. These reduced winding resistances may allow the converter 10 to have an increased power efficiency and to generate less heat as compared to a buck converter that incorporates a conventional coupled-inductor assembly.

In addition to the coupled-inductor assembly 14, the converter 10 includes a controller 18, high-side drive transistors 20₁-20_{N}, low-side drive transistors 22₁-22_{N}, a filter capacitor 24, and an optional filter inductor 26. A winding 16 and the high-side and low-side transistors 20 and 22 coupled to the winding compose a respective phase 12. For example, the winding 16₁ and transistors 20₁ and 22₁ compose the phase 12₁.

The controller 18 may be any type of controller suitable for use in a buck converter, is supplied by voltages VDD_{controller} and VSS_{controller}, and receives the regulated voltage Vout and a reference voltage Vref.

The high-side transistors 20₁-20_{N}, which are each switched “on” and “off” by the controller 18, are power NMOS transistors that are respectively coupled between input voltages VIN₁-VIN_{N} and the windings 16₁-16_{N}. Alternatively, the transistors 20₁-20_{N} may be other than power NMOS transistors, and may be coupled to a common input voltage. Moreover, the transistors 20₁-20_{N} may be integrated on the same die as the controller 18, may be integrated on a same die that is separate from the die on which the controller is integrated, or may be discrete components.

Similarly, the low-side transistors 22₁-22_{N}, which are each switched on and off by the controller 18, are power NMOS transistors that are respectively coupled between low-side voltages VL₁-VL_{N} and the windings 16₁-16_{N}. Alternatively, the transistors 22₁-22_{N} may be other than power NMOS transistors, and may be coupled to a common low-side voltage such as ground. Moreover, the transistors 22₁-22_{N} may be integrated on the same die as the controller 18, may be integrated on a same die that is separate from the die on which the controller is integrated, may be integrated on a same die as the high-side transistors 20₁-20_{N}, may be integrated on respective dies with the corresponding high-side transistors 20₁-20_{N} (e.g., transistors 20₁ and 22₁ on a first die, transistors 20₂ and 22₂ on a second die, and so on), or may be discrete components.

The filter capacitor 24 is coupled between Vout and a voltage VSS_{cap}, and works in concert with the windings 16₁-16_{N} and the filter inductor 26 (if present) to maintain the amplitude of the steady-state ripple component of the regulated output voltage Vout within a desired range that may be on the order of hundreds of microvolts to tens of millivolts. Although only one filter capacitor 24 is shown, the converter 10 may include multiple filter capacitors coupled in electrical parallel. Furthermore, VSS_{cap} may be equal to VSS_{controller} and to VL₁-VL_{N}; for example, all of these voltages may equal ground.

As further discussed below, the filter inductor 26 may be omitted if the leakage inductances of the windings 16₁-16_{N} are sufficient to perform the desired inductive filtering function. In some applications, omission of the filter inductor 26 is desired to reduce the size and component count of the converter 10.

Each of the windings 16₁-16_{N} of the coupled-inductor assembly 14 may be modeled as a self inductance L and a resistance DCR. For purposes of discussion, only the model components of the winding 16₁ are discussed, it being understood that the model components of the other windings 16₂-16_{N} are similar, except for possibly their values.

The self inductance L₁ of the winding 16₁ may be modeled as two zero-resistance inductances: a magnetic-coupling inductance LC₁, and a leakage inductance Lₗₑₐₖ₁. When a current flows through the winding 16₁, the winding generates a magnetic flux. The value of the coupling inductance LC₁ is proportional to the amount of this flux that is coupled to other windings 16₂-16_{N}, and the value of the leakage inductance Lₗₑₐₖ₁ is proportional to the amount of the remaining flux, which is not coupled to the other windings 16₂-16_{N}. In one embodiment, LC₁=LC₂= . . . =LC_{N}, and Lₗₑₐₖ₁=Lₗₑₐₖ₂= . . . =L_{leakN}, although inequality among the coupling inductances LC or the leakage inductances Lₗₑₐₖ is contemplated. Furthermore, in one embodiment, the respective magnetic-coupling coefficients between pairs of coupling inductances LC are equal (e.g., a current through LC₁ magnetically induces respective equal currents in LC₂, . . . LC_{N}), although unequal coupling coefficients are contemplated.

The resistance DCR₁ is the resistance of the winding 16₁ when a constant voltage V is applied across the winding and causes a constant current I to flow through the winding. That is, DCR₁=V/I.

As discussed below in conjunction with FIGS. 2-7, one may design the coupled-inductor assembly 14 so that the DCR of each winding 16 is reduced as compared to the DCRs of the windings in conventional coupled-inductor assemblies.

Reducing the DCR of one or more of the windings 16₁-16_{N} reduces the amount of power (I²·DCR) that the windings (and thus the coupled-inductor assembly 14) consume, and thus reduces the amount of heat that the windings (and thus the coupled-inductor assembly) generate.

Consequently, a coupled-inductor assembly 14 having one or more windings with reduced DCRs may allow the converter 10 to be more power efficient and to generate less heat than a converter that includes a conventional coupled-inductor assembly.

Still referring to FIG. 1, the operation of the buck converter 10 is discussed. For brevity, the operation of only phase 12₁ is discussed, it being understood that the other phases operate in a similar fashion.

While the high-side transistor 20₁ is on and the low-side transistor 22₁ is off, an increasing current i₁ flows from VIN₁, through the transistor 20₁, winding 16₁, and filter inductor 26 (if present), and to the capacitor 24 and to a load 28 that is supplied by Vout. This increasing current i₁ generates a magnetic flux that induces respective currents to flow through the coupled phases 12₂-12_{N}.

In contrast, while the high-side transistor 20₁ is off and the low-side transistor 22₁ is on, the current i₁ flows from VL₁, through the transistor 22₁, winding 16₁ and filter inductor 26 (if present), and to the capacitor 24 and to the load 28. The current i₁ may be increasing or decreasing depending on whether the current(s) flowing through one or more other windings magnetically induces a current(s) to flow through the phase 12₁.

The controller 18 compares Vout to Vref, and controls the high-side and low-side transistors 20₁-20_{N} and 22₁-22_{N} to maintain a predetermined constant relationship between Vout and Vref in the steady state, e.g., Vout=2 Vref. For example, as current drawn by the load 28 increases, the controller 18 may increase the on times or duty cycles of the high-side transistors 20₁-20_{N} to accommodate the increased load current; conversely, as the load current decreases, the controller may decrease the on times or duty cycles of the high-side transistors. The controller 18 may use a pulse-width-modulation (PWM) technique, a constant-on-time technique, or another technique to control the on and off times of the high-side and low-side transistors.

Alternate embodiments of the buck converter 10 are contemplated. For example, the converter 10 may be modified to generate Vout having a negative value.

Further descriptions of coupled-inductor power supplies and explanations of their potential advantages over non-coupled-inductor power supplies appear in the following references, which are incorporated by reference: Wong et al., Investigating Coupling Inductors In The Interleaved QSW VRM, IEEE 2000; Park et al., Modeling And Analysis Of Multi-Interphase Transformers For Connecting Power Converters In Parallel, IEEE 1997.

FIG. 2 is a perspective view of an embodiment of a coupled-inductor assembly 30, which one may use as the coupled-inductor assembly 14 in the buck converter 10 of FIG. 1. The structure 30 includes windings 32₁-32_{N}, each of which may have a lower DCR than a winding of a conventional coupled-inductor assembly.

In addition to the windings 32₁-32_{N}, the coupled-inductor assembly 30 includes a core 34 having winding forms 36₁-36_{N} and members 38 and 40, which interconnect the forms. That is, using a ladder analogy, the forms 36₁-36_{N} are the rungs of the ladder, and the members 38 and 40 are the rails to which the rungs are connected. Spaces 41₁-41_{N-1} are located between the forms 36₁-36_{N}.

Each winding 32₁-32_{N} is formed from a respective conductor 42₁-42_{N}, which has a respective width W₁-W_{N}, is partially wound about a corresponding form 36₁-36_{N}, and extends beneath and adjacent to the remaining forms. For example, the winding 32₁ is formed from a conductor 42₁ that is partially wound about the form 36₁ and extends beneath and adjacent to the remaining forms 36₂-36_{N}. Similarly, the winding 32₂ is formed from a conductor 42₂ that is partially wound about the form 36₂ and extends beneath and adjacent to the remaining forms 36₁ and 36₃-36_{N}, and so on. The conductors 42₁-42_{N} may be made from any suitable conductive material such as copper or another metal, and may, but need not be, electrically insulated from the forms 36₁-36_{N}.

Because each conductor 42 is only partially wound about a respective form 36, the respective partial-turn winding 32 may be shorter, and thus may have a smaller DCR, than a conventional winding that may be wound about a form multiple times, i.e., that may have multiple turns. Furthermore, partially winding the conductor 42 may allow the conductor to be wider, and thus have a still smaller DCR, than a conductor that forms a conventional multi-turn winding.

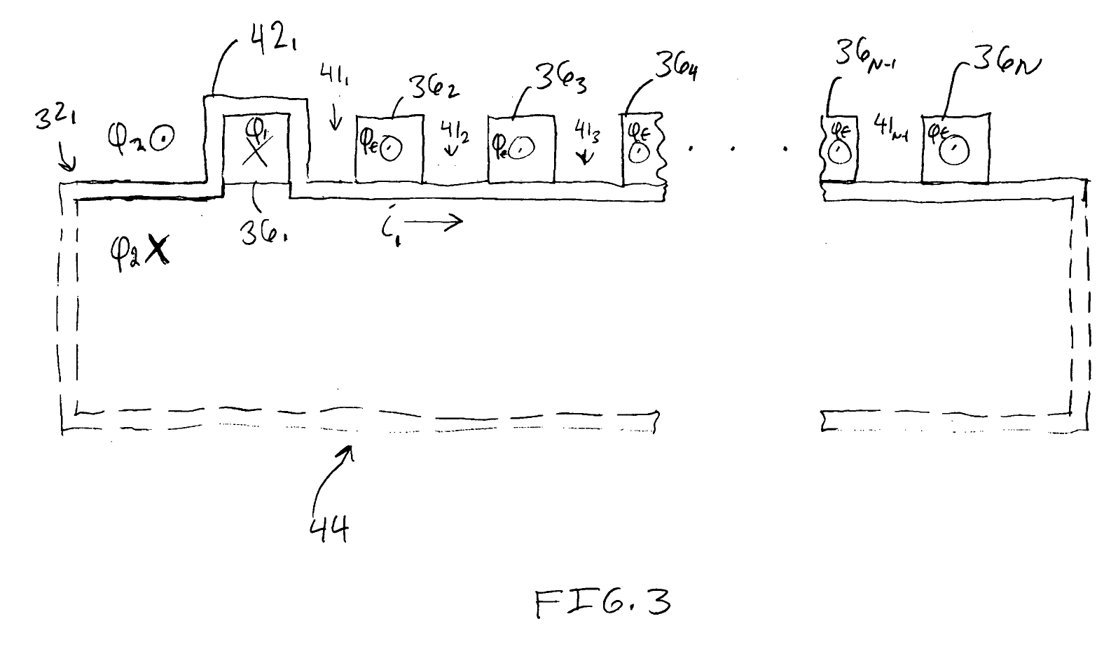

FIG. 3 is a cut-away side view of the coupled-inductor assembly 30 of FIG. 2 taken along line A-A, and of a conductive “loop” 44 partially formed by the winding 42₁. The portions of the loop 44 not formed by the winding 42₁ may be formed by, e.g., one or more conductive traces on a printed circuit board to which the coupled-inductor assembly is mounted.

Referring to FIGS. 2 and 3, the operation of the coupled inductor assembly 30 is described when a current i₁ flows through the conductor 42₁ in the direction shown, it being understood that the operation is similar when a current flows through the other conductors 42. For purposes of example, it is assumed that the entire core 34 (the forms 36₁-36_{N} and the members 38 and 40) is formed from the same magnetic material. It is also assumed that the forms 36₁-36_{N} have the same dimensions and that the conductors 42₁-42_{N} have the same dimensions. Furthermore, it is assumed that the coupled-inductor assembly 30 is mounted to a printed circuit board such that the forms 36₂-36_{N} do not pass inside the loop 44.

As the current i₁ flows through the conductive loop 44, it generates a total magnetic flux φ_{T}. In a first-order approximation, a first portion φ₁ of the total flux φ_{T} flows through the form 36₁, and a second portion φ₂ of the total flux φ_{T} flows outside of the form 36₁ such that φ_{T} is given by the following equation:

φ_{T}=φ₁+φ₂ (1)

The first flux portion φ₁ flows through, and is equally divided among, the remaining forms 36₂-36_{N} such that the flux φ_{f} flowing through each of the remaining forms is given by the following equation:

φ_{f}=φ₁/(N−1) (2)

Therefore, the first flux portion φ₁ is the coupling flux, because it magnetically couples the winding 32₁ to the windings 32₂-32_{N}. That is, when φ1 is time varying (i.e., dφ₁/dt ≢0 in response to dᵢ/dt≢0), it induces in each of the other conductors 42₂-42_{N} a respective current i_{f} that is proportional to φ_{f}, where, in this embodiment, i_{f}(t) has the same direction as i₁.

Conversely, the second flux portion φ₂ is the leakage flux, because it does not magnetically couple the winding 32₁ to any of the windings 32₂-32_{N}.

Therefore, referring to FIGS. 1-3:

LC₁/L₁˜φ₁/φ_{T} (3)

Lₗₑₐₖ₁/L₁˜φ₂/φ_{T} (4)

φ₁/φ_{T}˜R₂/(R₁+R₂) (5)

φ₂/φ_{T}˜R₁/(R₁+R₂) (6)

LC₁/L₁˜R₂/(R₁+R₂) (7)

Lₗₑₐₖ₁/L₁˜R₁/(R₁+R₂) (8)

where R₁ is the reluctance of the path through which the coupling flux φ₁ traverses the core 34, and R₂ is the reluctance of the path outside of the core through which the leakage flux φ₂ flows.

Consequently, one may vary the values of LC₁ and Lₗₑₐₖ₁ by varying the reluctances R₁ and R₂. One may also vary the values of LC₁ and Lₗₑₐₖ₁ by varying parameters other than R₁ and R₂, although a discussion of these other parameters is omitted for brevity.

Furthermore, because DCR₁ of the partial winding 32₁ may be smaller than the DCR of a conventional multi-turn winding, the power consumed and heat generated by the winding 32₁ while the current i₁ flows therethrough may be reduced relative to the power consumed and heat generated by the conventional winding for a given value of i₁.

Referring again to FIGS. 2 and 3, alternate embodiments of the coupled-inductor assembly 30 are contemplated. For example, although the members 38 and 40 are described as having the same dimensions and as being parallel to one another, these members may have different dimensions and make angles with one another. Similarly, although the forms 36₁-36_{N} are described as having the same dimensions and as being parallel to one another, these forms may have different dimensions and make angles with one another. Furthermore, although described as being made of the same material and being integral with one another, the forms 36₁-36_{N} and the members 38 and 40 may be made from different materials, and may not be integral with one another. Moreover, although shown as having the same widths W and thicknesses, the conductors 42₁-42_{N} may have different widths or thicknesses. In addition, although the spaces 41₁-41_{N-1} between the forms 36₁-36_{N} are shown as having the same dimensions, the spaces may have different dimensions. Furthermore, although all of the windings 32₁-32_{N} are described as being partial-turn windings, one or more of these windings may be single- or multi-turn windings. Moreover, although each winding 32₁-32_{N} is shown wound about three sides of a respective form 36₁-36_{N}, one or more of the windings may be wound about fewer or more than three sides, including being wound about only a fraction of a form side. For example, the conductor 42₁ , may be wound completely about the top and right sides of the form 36₁, but only half way about the left side of the form 36₁, or not wrapped about any portion of the left side.

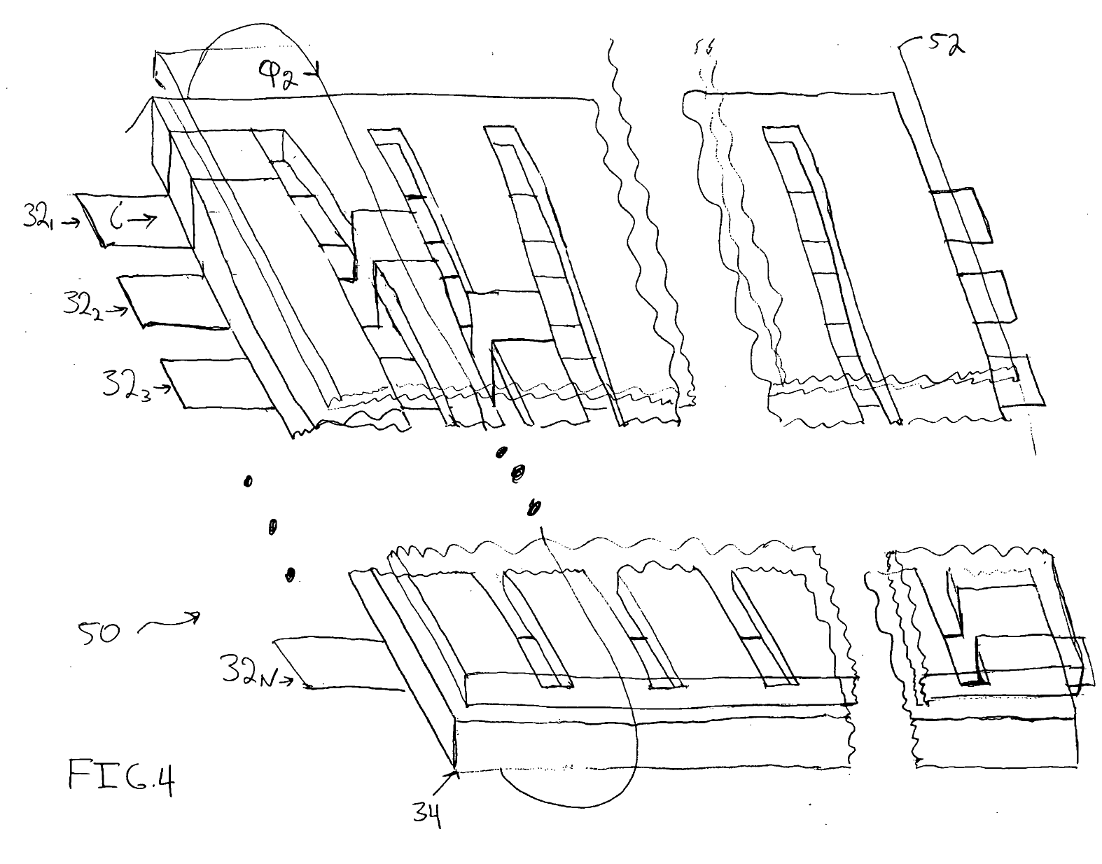

FIG. 4 is a perspective view of an embodiment of a coupled-inductor assembly 50, which one may use as the coupled-inductor assembly 14 of FIG. 1. In FIG. 4, like numerals identify components that are common to the assembly 50 and to the coupled-inductor assembly 40 of FIGS. 2-3. Furthermore, although a leakage-inductance plate 52 is shown as being transparent to permit viewing of the underlying core 34 in FIG. 4, the plate may be made from a material that is not transparent.

The coupled-inductor assembly 50 is similar to the coupled-inductor assembly 40 of FIGS. 2-3, except that the assembly 50 includes the plate 52, which adjusts the leakage inductances Lₗₑₐₖ₁-L_{leakN} (FIG. 1) of the windings 32₁ -32_{N}. For example purposes, only the adjustment of the leakage inductance Lₗₑₐₖ₁ of the winding 32₁ is described, it being understood that the adjustment of the leakage inductances Lₗₑₐₖ₂-L_{leakN} of the windings 32₂-32_{N} may be similar.

As discussed above in conjunction FIGS. 2-3, a current i₁ flowing through the winding 32₁ generates a leakage flux φ₂, which flows through a leakage path that is outside of the core 34.

Because the plate 52 is outside of the core 34, the plate forms part of the leakage path through which the leakage flux φ₂ flows.

Therefore, in a first-order approximation, the reluctance R_{P} of the plate 52 is in series with the reluctance R_{M} of the material (e.g., air) that forms the remaining part of the leakage path.

Because R_{M} is typically greater than R_{P}, the plate 52 reduces the overall reluctance of the leakage path (as compared to the reluctance of a leakage path formed entirely from, e.g., air), and, therefore, per equation (8), increases the value of the leakage inductance of the winding 32₁ for a given core reluctance—in equation (8), Lₗₑₐₖ₁ represents the leakage inductance of the winding 32₁, R₁ represents the reluctance of the core 34, and R₂ represents the overall reluctance of the leakage path of which the plate 52 is a part.

One may, therefore, specify the parameters of the plate 52 to give the desired values for the leakage inductances Lₗₑₐₖ₁-L_{leakN} of the windings 32₁-32_{N}. Parameters that affect the reluctance of the plate 52 itself include the material from which the plate is made and the dimensions of the plate. And other parameters that affect the reluctance of the leakage path include the placement and orientation of the plate relative to the core 34. For example, one may specify the parameters of the plate 52 to give values for Lₗₑₐₖ₁-L_{leakN} sufficient to omit the filter inductor 26 (FIG. 1) from the buck converter 10 (FIG. 1). Furthermore, one may specify the parameters of the plate 52 such that the leakage inductances Lₗₑₐₖ₁-L_{leakN} are not all equal to one another.

Depending on the specified parameters, the plate 52 may be mounted directly to the core 34, or may be mounted to a spacer (not shown in FIG. 4) that is disposed between the core and the plate. The spacer may be made from a material that has a significantly higher reluctance than the plate 52 such that the spacer has negligible affect on the values of Lₗₑₐₖ₁-L_{leakN}.

Still referring to FIG. 4, other embodiments of the coupled-inductor structure 50 are contemplated. For example, the plate may be mounted along the bottom or along one of the sides of the core 34. Furthermore, the plate 52 may have any size and shape and may not be planar. For example, the plate may be in the form a partial or full enclosure around the core 34. Where the plate 52 forms a closed loop around the core 34, then it forms a complete leakage path through the surrounding material (e.g., air), and thus may further decrease the leakage reluctance, and thus may further increase one or more of the leakage inductances Lₗₑₐₖ₁-L_{leakN}. Moreover, the plate 52 may have a shape that is different from the shape of the core, and may have an orientation that is different from the illustrated orientation. In addition, the coupled-inductor assembly 50 may include one or more of the alternative embodiments described above for the coupled-inductor assembly 40 of FIGS. 2-3.

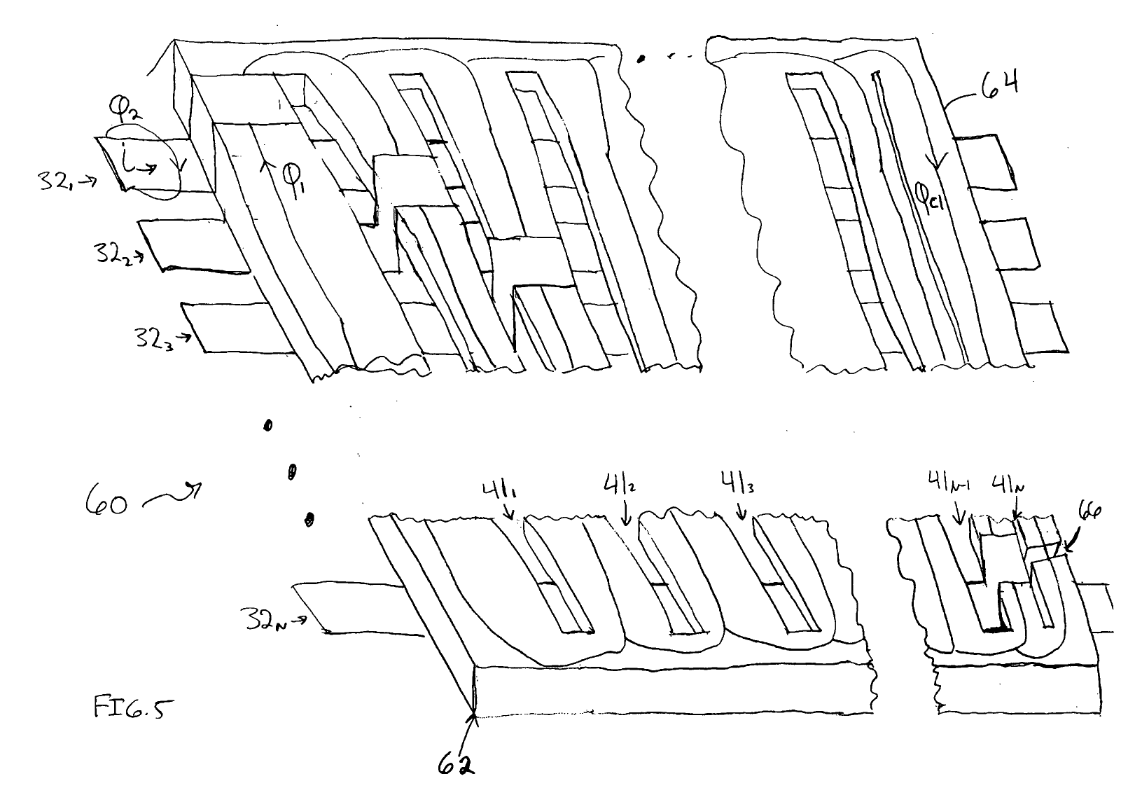

FIG. 5 is a perspective view of an embodiment of a coupled-inductor assembly 60, which may be used as the coupled-inductor assembly 14 of FIG. 1. In FIG. 5, like numerals identify components that are common to the assembly 60 and to the assembly 30 of FIGS. 2-3.

The coupled-inductor assembly 60 is similar to the coupled-inductor assembly 30 of FIGS. 2-3, except that the assembly 60 includes a core 62 having a leakage form 64 for adjusting the leakage inductances Lₗₑₐₖ₁-L_{leakN} of the windings 32₁-32_{N}. For example purposes, only the adjustment of the leakage inductance Lₗₑₐₖ₁ of the winding 32₁ is described, it being understood that the adjustment of the leakage inductances Lₗₑₐₖ₁-L_{leakN} of the windings 32₂-32_{N} may be similar.

As discussed above in conjunction FIGS. 2-3, a current i flowing through the winding 32₁ generates a core flux φ₁ and a leakage flux φ₂, which flows through a leakage path that is outside of the core 62.

However, unlike in the core 34 of FIGS. 2-3, a portion φ_{cl} of the core flux φ₁ flows through the leakage form 64, and thus does not induce a current in any of the windings 32₂-32_{N}.

Therefore, φ_{cl} is also leakage flux, such that in a first-order approximation, the total leakage flux φ_{L} generated by the current i is given by the following equation:

φ_{L}=φ₂+φcl (9)

Because the leakage inductance Lₗₑₐₖ₁ of the winding 32₁ is proportional to φ_{L}, the leakage form 64 reduces the overall reluctance of the effective leakage path, and thus increases the value of the leakage inductance Lₗₑₐₖ₁ for a given value of the self inductance L₁.

Furthermore, if the reluctance R_{c1} of the leakage form 64 is significantly less (e.g., on the order of ten or more times less) than the reluctance of the non-core leakage path through which φ₂ flows, then the total leakage flux φ_{L} may be approximated as:

φ_{L}≈φ_{cl} (10)

### This approximation may cause the leakage inductance Lₗₑₐₖ₁ of the winding 32₁ to depend primarily on the reluctance R_{c1} of the leakage form 64.

One may, therefore, specify the reluctance R_{c1} of the leakage form 64 to give the desired values for the leakage inductances Lₗₑₐₖ₁-L_{leakN} of the windings 32₁-32_{N}. Parameters that affect the reluctance R_{c1} of the leakage form 64 include the material from which the form is made, the dimensions of the form, the dimensions of an optional gap 66 in the form, and the material inside of the gap. In a first-order approximation, the gap 66 is in magnetic series with the remaining portion of the leakage form 64; consequently, the total reluctance R_{c1} of the leakage form is the sum of the reluctance R_{gap} of the gap and the reluctance of the remaining portion Rᵣₚ. The reluctance of the gap 66 depends on, e.g., its width and other dimensions, and the material that fills the gap.

As discussed above in conjunction with FIG. 4, one may specify the reluctance R_{c1} of the leakage form 64 to give values for the leakage inductances Lₗₑₐₖ₁-L_{leakN} of the windings 32₁-32_{N} that allow one to omit the filter inductor 26 (FIG. 1) from the buck converter 10 (FIG. 1).

Still referring to FIG. 5, other embodiments of the coupled-inductor assembly 60 are contemplated. For example, the leakage form 64 may have any size and shape, as may the space 41_{N} that separates the leakage form from the form 36_{N}. Furthermore, although shown as being integrally formed with the remaining portion of the core 62, the leakage form 64 may be attached or otherwise non-integral with the remaining core portion. Moreover, although the core 62 is described as including only one leakage form 64, the core may include multiple leakage forms. In addition, the coupled-inductor assembly 60 may include a plate, like the plate 52 of FIG. 4, to further adjust the leakage inductances Lₗₑₐₖ₁-L_{leakN}. In addition, the coupled-inductor assembly 60 may include one or more of the alternative embodiments described above for the coupled-inductor assemblies 30 and 50 of FIGS. 2-4.

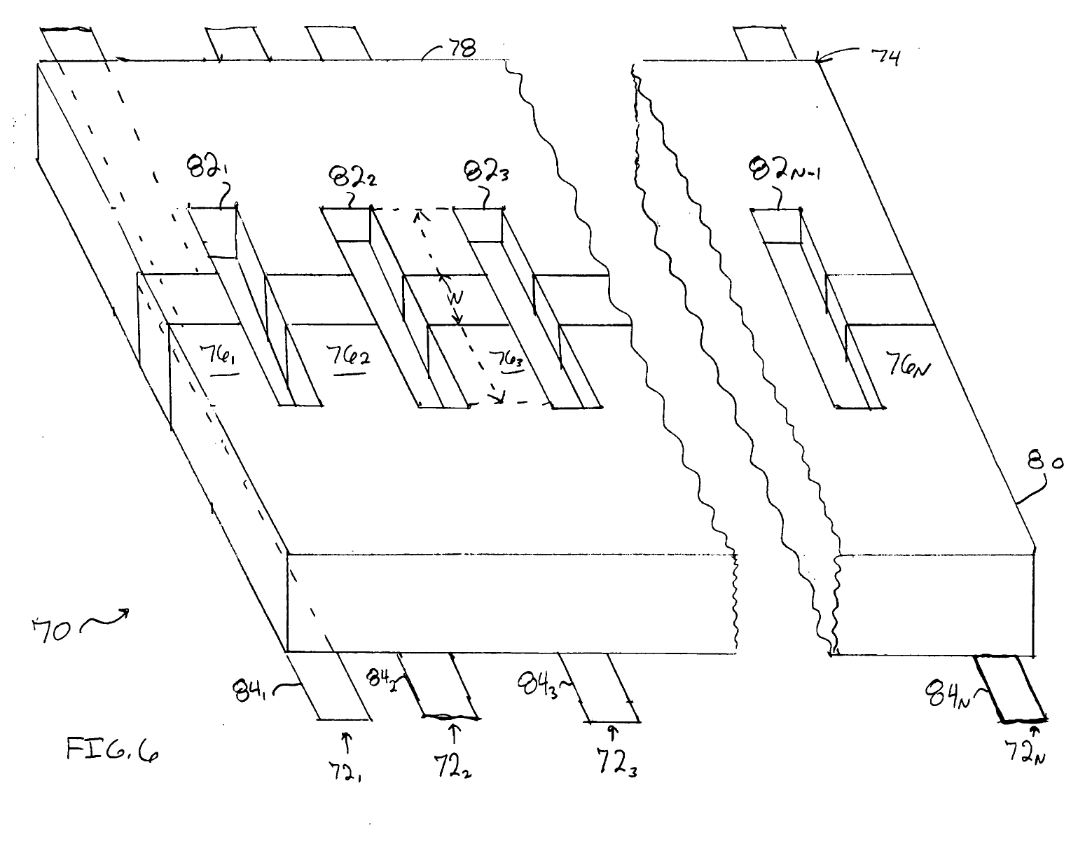

FIG. 6 is a perspective view of an embodiment of a coupled-inductor assembly 70, which may be used as the coupled-inductor assembly 14 of FIG. 1. Like the windings 32₁-32_{N} of the assembly 30 of FIGS. 2-3, the windings 72₁-72_{N} of the assembly 70 may each have a lower DCR than a winding of a conventional coupled-inductor assembly.

In addition to the windings 72₁-72_{N}, the coupled-inductor assembly 70 includes a core 74 having winding forms 76₁-76_{N} and members 78 and 80, which interconnect the forms. Spaces 82₁-82_{N-1} are disposed between the forms 76₁-76_{N}.

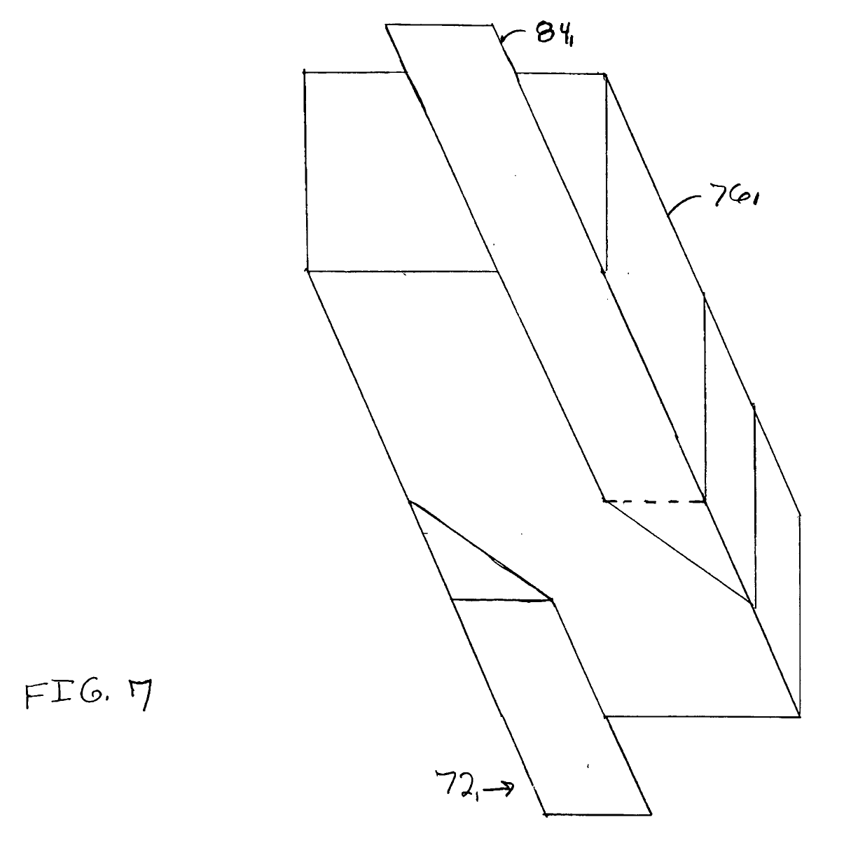

FIG. 7 is a perspective view of the back side of the form 76₁, it being understood that the back sides of the other forms 76₂-76_{N} may be similar.

Referring to FIGS. 6 and 7, each winding 72₁-72_{N} is formed from a respective conductor 84₁-84_{N}, which has a respective width W₁-W_{N}, is partially wound about a corresponding form 76₁-76_{N}, and extends beneath and adjacent to the bottom of the form about which it is wound. For example, the winding 72₁ is formed from a conductor 84₁ which is partially wound about the form 76₁. One end of the conductor 84₁ extends beneath and adjacent to the bottom of the form 76₁ in one direction parallel to the form, and the other end of the conductor extends beneath and adjacent to the bottom of the form in the other direction. The conductors 84₁-84_{N} may be made from any suitable conductive material such as copper or another metal, and may, but need not be, electrically insulated from the respective forms 76₁-76_{N}.

Because each conductor 84₁-84_{N} is only partially wound about a respective form 76₁-76_{N}, the respective winding 72₁-72_{N} may be shorter, and thus may have a smaller DCR, than a conventional multi-turn winding. Furthermore, partially winding the conductor 84 may allow the conductor to be wider, and thus have a still smaller DCR, than a conductor that forms a conventional multi-turn winding.

One difference between the coupled-inductor assembly 30 of FIG. 2 and the coupled-inductor assembly 70 is that because the conductors 84₁-84_{N} do not extend beneath and adjacent to the forms 76 about which they are not wound, the lengths of the forms may be independent from the number N of windings 72.

The operation of the coupled-inductor assembly 70 is similar to, and is in accordance with the same magnetic principles as, the operation of the coupled-inductor assembly 30 of FIGS. 2-3.

Still referring to FIGS. 6-7, alternate embodiments of the coupled-inductor assembly 70 are contemplated. For example, the assembly 70 may incorporate any of the alternatives described above in conjunction with the coupled-inductor assembly 30 of FIGS. 2-3. Furthermore, the assembly 70 may incorporate a leakage plate or leakage form to adjust the leakage inductances Lₗₑₐₖ₁-L_{leakN} of the windings 72₁-72_{N} as described above in conjunction with the coupled-inductor assemblies 50 and 60 of FIGS. 4 and 5, and may incorporate any of the alternatives described above in conjunction with these coupled-inductor assemblies.

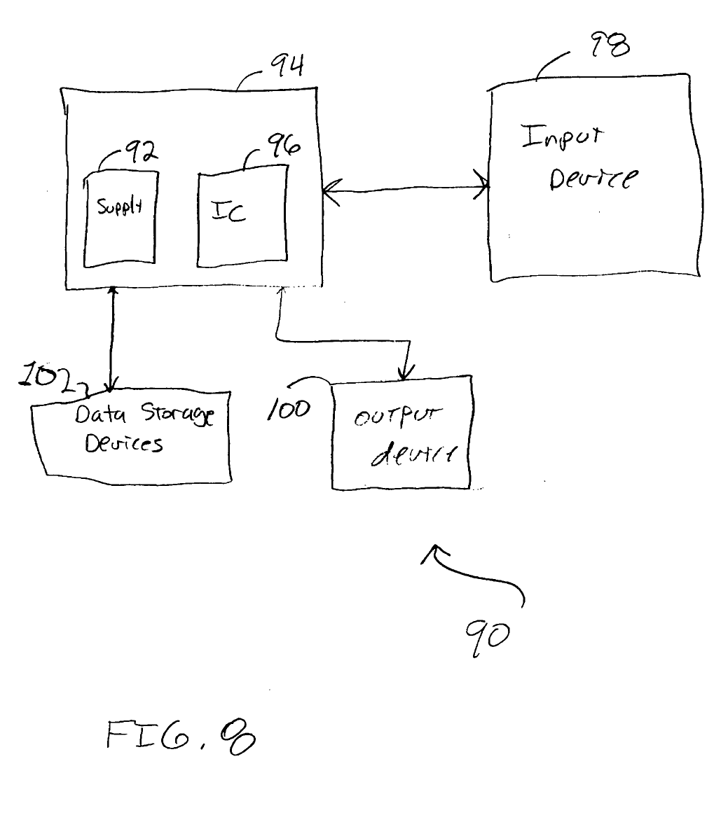

FIG. 8 is a block diagram of a system 90 (here a computer system), which may incorporate a power supply (such as the buck converter 10 of FIG. 1) 92 that includes one or more of the coupled-inductor assemblies 30, 50, 60, and 70 of FIGS. 2-7.

The system 90 includes computer circuitry 94 for performing computer functions, such as executing software to perform desired calculations and tasks. The circuitry 94 typically includes a controller, processor, or one or more other integrated circuits (ICs) 96, and the power supply 92, which provides power to the IC(s) 96. One or more input devices 98, such as a keyboard or a mouse, are coupled to the computer circuitry 94 and allow an operator (not shown) to manually input data thereto. One or more output devices 100 are coupled to the computer circuitry 94 to provide to the operator data generated by the computer circuitry. Examples of such output devices 100 include a printer and a video display unit. One or more data-storage devices 102 are coupled to the computer circuitry 94 to store data on or retrieve data from external storage media (not shown). Examples of the storage devices 102 and the corresponding storage media include drives that accept hard and floppy disks, tape cassettes, compact disk read-only memories (CD-ROMs), and digital-versatile disks (DVDs).

From the foregoing it will be appreciated that, although specific embodiments have been described herein for purposes of illustration, various modifications may be made without deviating from the spirit and scope of the invention. Furthermore, where an alternative is disclosed for a particular embodiment, this alternative may also apply to other embodiments even if not specifically stated.

What is claimed is:

1. A coupled-inductor assembly, comprising:
a core, including
first and second members, and
spaced-apart forms extending between the members; and a first conductor partially wound about a first one of the forms.

2. The coupled-inductor assembly of claim 1 wherein the core comprises a material having a magnetic permeability that is greater than the permeability of air.

3. The coupled-inductor assembly of claim 1 wherein:
the first member is substantially parallel to the second member; and
the forms are substantially parallel to one another and are substantially perpendicular to the first and second members.

4. The coupled-inductor assembly of claim 1, further comprising:
a second conductor partially wound about a second one of the forms and spaced apart from the first form; and
wherein the first conductor is spaced apart from the second form.

5. The coupled-inductor assembly of claim 1, further comprising:
a second conductor adjacent the first form and partially wound about a second one of the forms; and
wherein the first conductor is adjacent to the second form.

6. The coupled-inductor assembly of claim 1, further comprising:
a second conductor adjacent to only one side of the first form and wound about multiple, but fewer than all, sides of a second one of the forms; and
wherein the first conductor is wound about multiple, but fewer than all, sides of the first form and is adjacent to only one side of the second form.

7. The coupled-inductor assembly of claim 1, further comprising:
a second conductor adjacent to only one side of the first form and wound about multiple, but fewer than all, sides of a second one of the forms; and
wherein the first conductor is wound about multiple sides of the first form, the multiple sides excluding the side of the first form to which the second conductor is adjacent, and is adjacent to only one side of the second form, the one side of the second form being different than the sides of the second form about which the second conductor is wound.

8. The coupled-inductor assembly of claim 1 wherein:
the first form has a width; and
the conductor has a width that is substantially the same as the width of the first form.

9. The coupled-inductor assembly of claim 1 wherein:
the first form has an axis;
a first portion of the first conductor is partially wound about the first form in a direction that is substantially perpendicular to the axis; and
a second portion of the first conductor is substantially parallel to the axis.

10. The coupled-inductor assembly of claim 1 wherein:
the first form has a first magnetic reluctance;
a second one of the forms has a second magnetic reluctance that is different than the first magnetic reluctance.

11. The coupled-inductor assembly of claim 1 wherein a second one of the forms has a gap.

12. The coupled-inductor assembly of claim 1 wherein no conductor accessible from outside of the coupled-inductor assembly is wound about a second one of the forms.

13. The coupled-inductor assembly of claim 1, further comprising a plate disposed adjacent to the core.

14. A circuit, comprising:
a transformer including
a core having
first and second members, and
spaced-apart forms extending between the members,
a first conductor partially wound about a first one of the forms; and
a driver operable to cause a current to flow through the first conductor.

15. A regulator, comprising:
a regulator output node operable to provide an output voltage;
a coupled-inductor assembly, including
a core having
first and second members, and
spaced-apart forms extending between the members,
a first conductor partially wound about a first one of the forms, having an input node, and having an output node coupled to the regulator output node, and
a second conductor wound about a second one of the forms, having an input node, and having an output node coupled to the regulator output node;
a driver circuit coupled to the input nodes of the first and second conductors and operable to cause a first current to flow through the first conductor during a first period and to cause a second current to flow through the second conductor during a second period; and
a controller coupled to the regulator output node and to the driver circuit and operable to maintain the output voltage within a predetermined range.

16. The regulator of claim 15 wherein the second conductor is partially wound about the second form.

17. The regulator of claim 15 wherein the controller is operable to maintain the output voltage within a predetermined range by:
comparing the output voltage to a reference voltage; and
controlling the driver circuit in response to a difference between the output voltage and reference voltage.

18. A system, comprising:
a regulator, comprising
a regulator output node operable to provide an output voltage;
a coupled-inductor assembly, including
a core having
first and second members, and
spaced-apart forms extending between the members,
first conductor partially wound about a first one of the forms, having an input node, and having an output node coupled to the regulator output node, and
a second conductor wound about a second one of the forms, having an input node, and having an output node coupled to the regulator output node,
a driver coupled to the input nodes of the first and second conductors and operable to cause a first current to flow through the first conductor during a first period and to cause a second current to flow through the second conductor during a second period, and
a controller coupled to the regulator output node and to the driver circuit and operable to maintain the output voltage within a predetermined range; and
a circuit having a supply node coupled to the regulator output node.

19. The system of claim 18 wherein the controller and the circuit are disposed on a same die.

20. The system of claim 18 wherein:
the controller is disposed on a first die; and
the circuit is disposed on a second die.

21. A method, comprising:
generating magnetic flux with a first current that flows through a first conductor and into an output node, the first conductor partially wrapped around a first form of a core;
directing a first part of the magnetic flux through the first form; and
directing a first portion of the first part of the magnetic flux through a second form of the core about which a second conductor is wrapped, the first portion of the flux causing a second current to flow through the second conductor and into the output node.

22. The method of claim 21 wherein the second conductor is partially wrapped around the second form.

23. The method of claim 21, further comprising directing a second portion of the first part of the magnetic flux through a third form of the core around which a third conductor is partially wrapped, the second portion causing a third current to flow through the third conductor into the output node.

24. The method of claim 21, further comprising directing a third portion of the first part of the magnetic flux through a leakage form of the core, the third portion causing no current to flow into the output node.

25. The method of claim 21, further comprising directing a second part of the magnetic flux through a leakage path that includes a leakage member and that does not include the first form.
